(19) United States
(12) Patent Application Publication
(10) Pub. No.: US 2006/0242082 A1
(43) Pub. Date: Oct. 26, 2006

(54) Method and system for protecting of software application from piracy

(76) Inventors: Yanki Margalit, Ramat-Gan (IL); Dany Margalit, Ramat-Gan (IL)

Correspondence Address: HOFFMAN, WASSON & GITLER, P.C., CRYSTAL CENTER, SUITE 522, 2461 SOUTH CLARK STREET, ARLINGTON, VA, 22202, US

(21) Appl. No.: 11/186,854

(22) Filed: Jul. 22, 2005

Related U.S. Application Data
(60) Provisional application No. 60/631,150, filed on Nov. 29, 2004.

(51) Int. Cl. G06Q 99/00

(52) U.S. Cl. 705/59

(57) ABSTRACT

The present invention is directed to a method for protecting a software application from unauthorized use, the method comprising the steps of: executing a first part of the software application by a user's machine; executing a second part of the software application on a remote server accessible by the user's machine over a network, thereby keeping the second part away from the user's machine; and communicating between the first part and the second part via the network; whereby preventing hacking the software application. In another aspect, the present invention is directed to a software application, comprising: a first part, to be executed on a user's machine; a second part, to be executed on a remote server accessible by the user's machine over a network, thereby keeping the second part away from the user's machine; and a communication module, for communicating between the first part and the second part.

This is a continuation-in-part of U. S. Provisional Patent Application identified as Attorney's Docket 1411, delivered to the USPTO on Nov. 29, 2004, by FedEx shipment No. 621360074846.

### FIELD OF THE INVENTION

The present invention relates to the field of software protection.

### BACKGROUND OF THE INVENTION

The term Software Piracy refers herein to illegal copying, distribution, or use of software.

Despite the fact that most computer users today are aware that unauthorized use and duplication of software is illegal, many show a general disregard for the importance of treating software as valuable intellectual property. According to the BSA (Business Software Alliance) Seventh Annual Global Software Piracy Study, revenue losses due to piracy for the business software application market exceeded $29 billion in the year 2003.

The following are some familiar types of software piracy:

Softlifting: purchasing a single licensed copy of software and loading it onto several computers contrary to the license terms (for example, sharing software with friends, co-workers and others);

Uploading and downloading: making unauthorized cop ies of copyrighted software available to end users connected by modem to online service providers and/or the Internet;

Software counterfeiting: illegally duplicating and selling copyrighted software in a form designed to make it appear legitimate;

OEM unbundling: selling standalone software that was intended to be bundled with specific accompanying hardware;

Hard disk loading: installing unauthorized copies of software onto the hard disks of personal computers, often as an incentive for the end user to buy the hardware from that particular hardware dealer;

Renting: unauthorized selling of software for temporary use; and

Hacking: Altering the protection shield of a computer application, in order to enable unauthorized use of the application.

One solution to software piracy is the HASP™, manufactured by Aladdin Knowledge Systems Ltd. It is a family of products for protecting software applications (i.e. preventing its piracy) and also for Digital Right Management (DRM). The HASP family currently includes the following products:
HASP HL™, which is a hardware-based licensing and software protection system;
Privilege™, which is a software-based licensing, software protection and software distribution system;
Privilege Trialware Toolkit, for creating secure, controlled software trialware; and
HASP DocSeal™, which is a hardware-based system for protection of intellectual property and sensitive information in your HTML files.

For example, the HASP HL™ is distributed in the form of a token (also known as “dongle”) to be inserted into a USB port, or similar port (e.g. parallel port) of a computer. It is a hardware-based encryption engine used for encrypting and decrypting data for software protection. During runtime the HASP HL™ receives encrypted strings from the protected application and decrypts them in a way that cannot be imitated. The decrypted data that is returned from the HASP HL™ is employed by the protected application so that it affects the mode in which the program executes: it may load and run, it may execute only certain components, or it may not execute at all. The on-chip encryption engine of HASP employs a 128-bit AES Encryption Algorithm, Universal API, single license capacity, cross-platform USB, and more.

Another approach for software protection is based on a Local Licensing Server, i.e. a server that operates at an organization's private network and controls the licensing/protection functionality of one or more software products. For example, a local licensing server is provided with a pool of N licenses, i.e. no more than N copies of the program are allowed to be used at the same time. Each time a copy of the software is activated, the software “asks” the licensing server for permission to run. Each time a user runs the software application by a user, the licensing pool is decremented by one, and each time a user finishes working with the application, the licensing pool is incremented by one. In case where more than N users use the application at the same time, the server can refuse to enable additional licenses, charge the organization for extra use, etc., according to the licensing terms purchased by the organization.

Another well-known solution to software protection is the Product Activation. Product Activation, also known as Software Activation, is a unique business model providing more control over how a software application is distributed and used. In essence, it provides software protection, protecting intellectual property by limiting the number of times software can be installed. Typically, the objective of software activation is to allow installation of a software application on a single machine. Within a predetermined period after the installation (e.g. the first 30 days), the user must get the system ‘activated’, and only then he can use it. Activation involves communication between the machine on which the software application has been installed and a licensing server, typically over the Internet, and includes providing information about the hardware on which the application is installed. Assuming the software has been purchased legally, the remote server provides a release code to be recorded on the user's system. Each time the software application is invoked the code is checked against the hardware components of the machine (e.g. the type of display adapter, SCSI adapter, IDE Adapter, processor type, etc.) and execution is allowed only if the code corresponds to the expected one.

Since the product activation solution is tied to the user's hardware, any change in the user's hardware creates an obstacle to the ability to positively identify the user's machine. Replacing one machine by another requires the user to re-activate the software. Moreover, executing a licensed software application on more than one machine creates an additional obstacle.

Many software activation problems are solved by the token solution, since a token is a mobile hardware device, designed to impede duplication thereof, even by reverse engineering. However, from the manufacturer point of view, protecting a software application by a token incurs extra expenses since the token is a hardware element, a token has amortization, changing the content of a token is an inconvenient procedure when the token is in the user's possession, etc.

While, for use within an organization, a licensing server solution is more suitable than a token solution, the licensing server solution also has drawbacks, such as overload, which may result in suspension of the activity of the software application within the organization, etc.

Therefore, it is an object of the present invention to provide a system for protecting a software application from piracy, which overcomes the problems of the prior art.

A further object of the present invention is to provide a solution for software piracy which can be implemented without hardware means.

Another object of the present invention is to provide a solution for protecting a software application, suitable for both organizations and individual users.

Other objects and advantages of the invention will become apparent as the description proceeds.

### SUMMARY OF THE INVENTION

In one aspect, the present invention is directed to a method for protecting a software application from unauthorized use, the method comprising the steps of: executing a first part of the software application by a user's machine; executing a second part of the software application on a remote server accessible by the user's machine over a network, thereby keeping the second part away from the user's machine; and communicating between the first part and the second part via the network; whereby preventing hacking the software application.

In another preferred aspect, the present invention is directed to a software application, comprising: a first part, to be executed on a user's machine, a second part, to be executed on a remote server accessible by the user's machine over a network (WAN, LAN, etc.), thereby keeping the second part away from the user's machine, and a communication module, for communicating between the first part and the second part, thus preventing hacking the software application.

Typically, the second part of the software application performs licensing activity (e.g. verifying that the application is executed according to licensing terms thereof) of a software application, or of a plurality of software applications.

According to another preferred embodiment of the invention, the first part, the second part, or even all the parts of the software application may be protected by a protection shield.

The second part of the software application may include an executable program. Alternatively or additionally, the second part of the software application may include a data object. Additionally, the data object includes a key (cryptographic key, identification key, etc.).

Preferably, the communication between the first part and the second part is secured. According to a preferred embodiment of the invention, the communication is selective.

### BRIEF DESCRIPTION OF THE DRAWONGS

The present invention may be better understood in conjunction with the following figures:

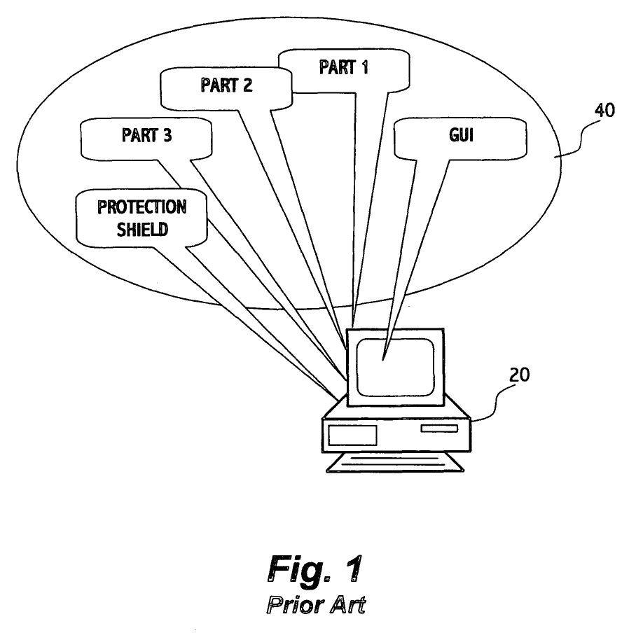

FIG. 1 schematically illustrates a typical protected software application, according to the prior art;

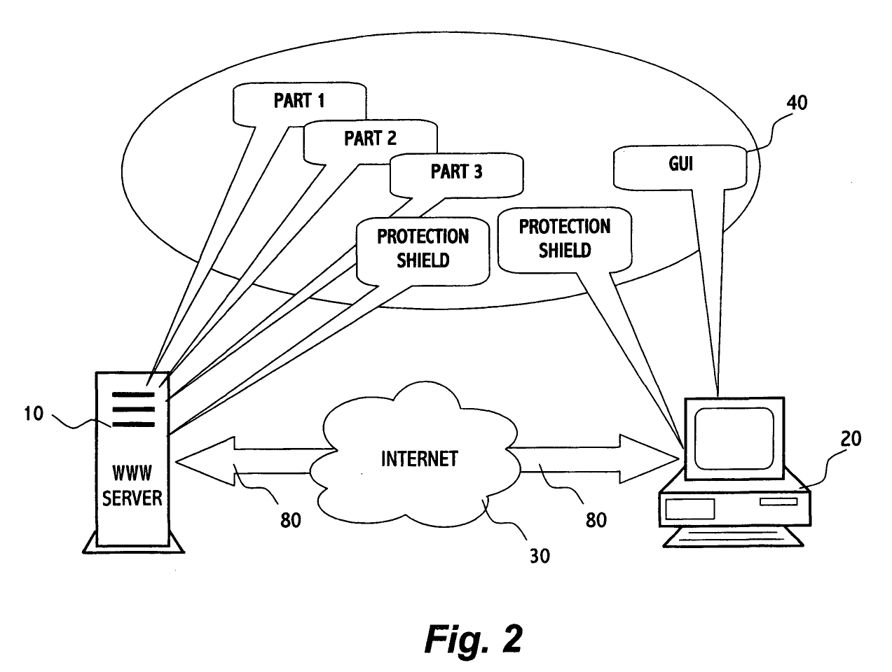

FIG. 2 schematically illustrates a deployment of the parts of the software application illustrated in FIG. 1, according to a first preferred embodiment of the present invention;

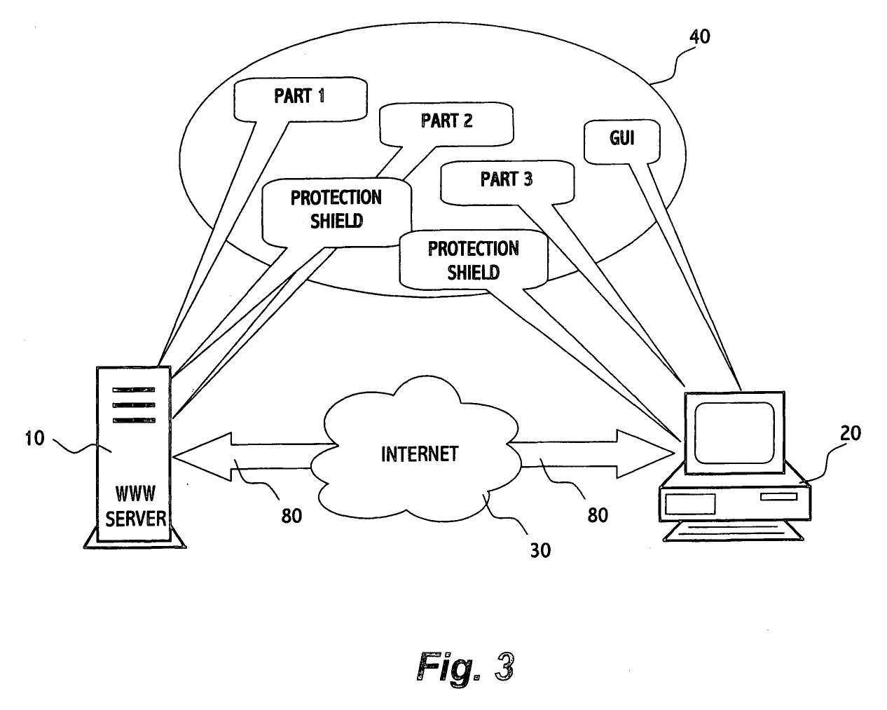

FIG. 3 schematically illustrates a deployment of the parts of the software application illustrated in FIG. 1, according to another preferred embodiment of the present invention;

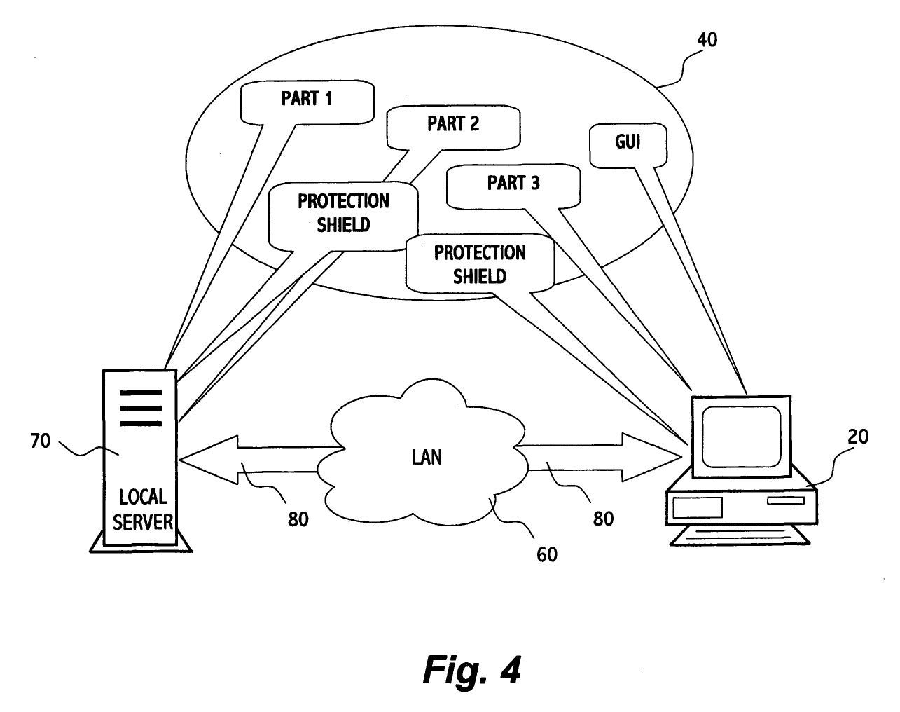

FIG. 4 schematically illustrates a deployment of the parts of the software application, according to yet another preferred embodiment of the present invention;

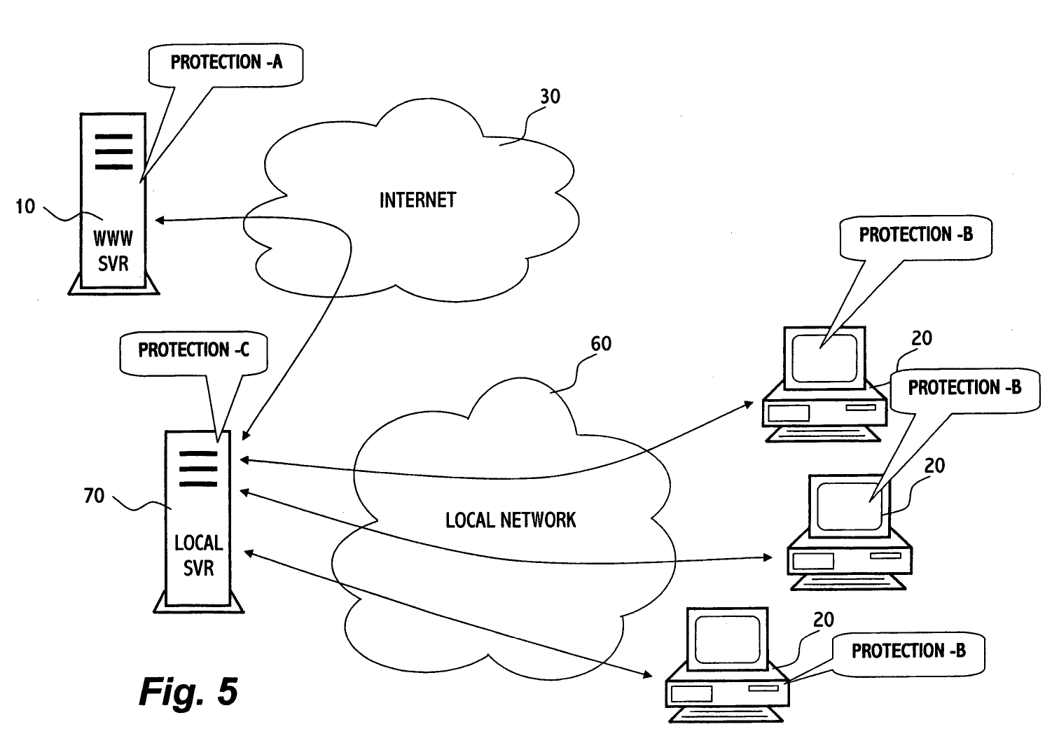

FIG. 5 schematically illustrates a deployment of the parts of the software application, according to still another preferred embodiment of the present invention; and

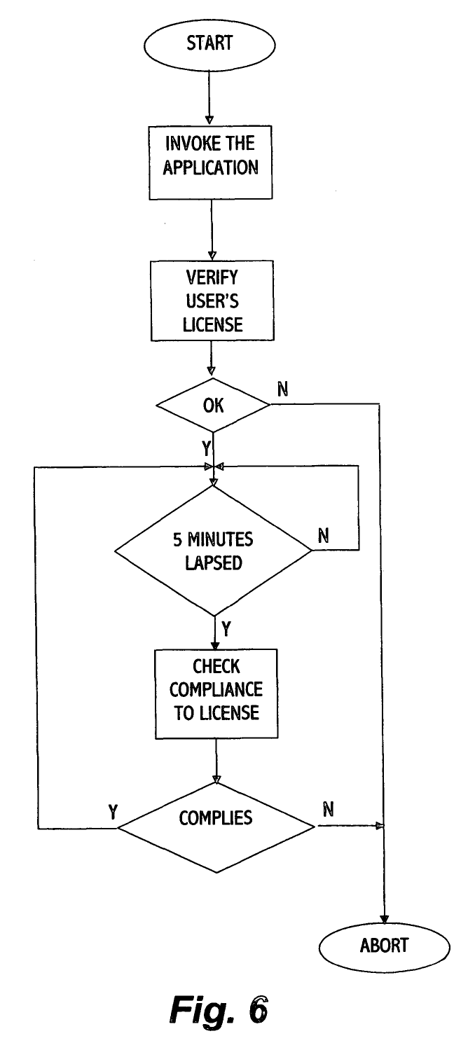

FIG. 6 is a flowchart of a process for protecting a software application, according to one preferred embodiment of the present invention.

### DETAILED DESCRIPTION OF PREFERRED EMBODIMENTS

The term Protection Shield or Security Shield refers herein to software and/or hardware part(s) added to a software application for protecting the software application from being used by unauthorized objects. A protection shield can be added to an application during its development, or to the distributed version of the application.

The term “software” refers in the art to computer instructions and/or data. The term “software application” refers in the art to programs and/or data oriented to perform some functionality. For example, word processors, spreadsheets, and database management systems fall under the category of software applications. The term “part of a software application” refers herein to less than the entirety of the components of a software application, whether the components are executable code or data. For example, one or more functions, a DLL, an executable (e.g. EXE) file, one or more scripts, one or more data files, one or more records of a database, one or more bytes, and any combination of the above, which includes less than the entirety of a software application, may each be termed as a “part” of a software application to which these components collectively belong.

FIG. 1 schematically illustrates a typical protected software application, according to the prior art. User's machine 20 executes a software application 40. The software application 40 comprises the following modules: Part 1, Part 2 and part 3, a GUI (Graphical User Interface), and a protection shield. All the parts are executed on user's machine 20.

One of the major reasons for the vulnerability of a software application to piracy is that all the parts of a software application are available to the user. The availability to the software parts to a user allows him to amend the files, whether they are executables or data files. One of the methods employed by hackers is tracing the code and data of the application while it is being executed. A hacker may use a debugger, which allows him to execute the application stepwise, to follow the operation it performs in each step, to examine the current content of variables and memory, etc. Thus, the availability of the files of a software application to a user, or even availability of the parts of a software application which are stored in the RAM while being executed, makes the software application vulnerable to hacking. Thus, with the appropriate effort, time and resources, a protection shield of a software application can be removed, resulting with an unprotected software application which can be distributed to other unauthorized users.

According to a preferred embodiment of the present invention, this problem is solved by keeping all the parts of the software application on a remote server, and executing these parts by the remote server or by another remote server instead of on the user's machine.

FIG. 2 schematically illustrates a deployment of the parts of the software application illustrated in FIG. 1, according to a preferred embodiment of the present invention. Instead of executing all the parts of the application 40 on the user's machine 20 as in the prior art, Part 1, Part 2 and Part 3 are executed on a remote server 10 which in accessible to the user's machine 20 through the Internet 30 via a communication channel 80. The connection between the user and the application is carried out by the GUI module 40, which is executed by the user's machine 20.

Since the application 40 is deployed on two platforms, the. user's computer. 20 and the remote server 10, the role of the protection shield is different than in the prior art. If the application's owner doesn't trust the operator of the server 10, or in order to gain a better protection level, the part of the program that runs on the remote server 10 can also be protected. The protection shield on the user's machine 20 can be less severe since the remote server 10 can control the way the application is utilized, e.g. how many users execute it, the identity of the users, etc. In addition, the data exchanged between the user's machine 20 and the remote server can also be protected, especially if the data has a confidential nature. This can be carried out, for example, by cryptographic methods such as encrypting the exchanged data, digitally signing the exchanged data, etc.

By preventing from a user to access the software application 40, the user cannot alter the software application, resulting with a better protection level in comparable to the prior art.

In one embodiment of the present invention, since the application does not operate on the user's machine 20, the interface with the user may be carried out by a browser or by a dedicated program thereof. This is illustrated in FIG. 2 by the GUI module executed by user's machine 20.

FIG. 3 schematically illustrates a deployment of the parts of the software application illustrated in FIG. 1, according to another preferred embodiment of the present invention. In this embodiment, Part 1 and Part 2 of the application are executed by the remote server 10, while Part 3 of the application is executed by the user's machine 20. Thus, not all parts of the program have to be executed on by remote server 10. In some cases it is adequate to protect only certain parts of the application, e.g. some core routines or a licensing module, and still obtain a good protection. These parts may be executed by the remote server 10.

According to another preferred embodiment of the present invention, the part of the software application 40 which runs on the remote server 10 relates to licensing of the software application 40.

FIG. 4 schematically illustrates a deployment of the parts of the software application, according to another preferred embodiment of the present invention. The difference between FIG. 3 and FIG. 4 is that in FIG. 3 some parts of the software application 40 are executed by a remote server 10 which is available to the user's machine 10 over a wide area network 30 (e.g. Internet), in FIG. 4 some parts of the software application 10 are executed by a local server 70 and are available to the user's machine 10 over a local area network 60.

The deployment illustrated in FIG. 3 differs from the prior art in at least the following respects:

According to the present invention the remote server is accessible over a wide area network whereas according to the prior art the remote server is accessible over a local area network. The difference is substantial since a local server is a part of the local area network, and therefore is more accessible to its users than the users of a wide area network. For example, since the infrastructure of a local area network (including its servers) is usually physically available to the users of the local area network, a licensing module operating at a local server can be debugged at least by the operator of the local area network.

The deployment illustrated in FIGS. 4 differs from the prior art in at least the following respects:

A licensing server, whether accessible via a local area network or via a wide area network, does not form an integral part of a protected software application according to the present invention. For example, according to the present invention, some core routines, which may or may not form part of the protection shield, may be executed on the remote server. The prior art, however, deals only with licensing, not with protection.

It is appreciated that since in the present invention the parts of a software application may be executed on a plurality of computer systems, it is desirable to allow the different parts of the application on different computers to intercommunicate. It is desirable that the communication channel be secured, i.e. provide encrypted communication or at least ensure that the content of the communicated information will not be understandable to unauthorized objects.

FIG. 5 schematically illustrates a deployment of the parts of the software application, according to a further embodiment of the present invention. A group of user machines 20 are connected by local network 60, and local network 60 is connected to the wide area network 30.

According to this embodiment, the protection activity is divided between the remote server 10 (the PROTECTION-A part), the local server 70 (the PROTECTION-C part) and the user's machine 20 (the PROTECTION-B part).

According to another preferred embodiment of the present invention, the licensing server, either the Web licensing server or the local licensing server or both, is operative to verify that the application is being operated according to the licensing terms purchased by the organization. The verification may be performed periodically or at random intervals. In one preferred embodiment, instead of or in addition to checking the authorization of a user to use the application upon activation of the application, the server checks at a given interval, such as every 5 minutes, how many authorized users are using the application simultaneously, and updates the number of available/used licenses in the licensing pool. In the event the number of users exceeds that allowed according to the license agreement, the licensing server may charge the organization for extra use, limit some functionalities of the application (e.g. suspend the Save option) to some of the users, drop out some users, etc.

In contrast to the prior art where the use of a software application is carried out only upon invoking the application, according to this embodiment of the present invention, verifying that the use of a software application complies with its licensing terms is also carried out during execution of the application.

FIG. 6 is a flowchart of a process for protecting a software application, according to a preferred embodiment of the present invention. After invoking the software application, the authorization of a user thereof to use the application is interrogated. As seen in FIG. 6, if use of the application by the user is not authorized, the application may be aborted. Alternatively, the user may be allowed to utilize limited features of the application or may be allowed limited use of the application. If use of the application by the user is authorized, an additional check is preformed at 5 minute intervals during the execution of the application. As described hereinabove, the additional check verifies that the user is authorized to use the software application under the licensing terms. In case where more users than allowed according to a license agreement use the application at the same time, the licensing server may charge the organization for additional fee, limit some functionalities of the application (e.g. suspend the Save option) to some of the users, drop out some users, etc.

It is appreciated that a local licensing server is better suited than a web licensing server to provide additional verification during executing of the software application, that it is being used in compliance with the licensing terms thereof. Performing such activity on a web licensing server may result in overloading the web server, due to the potentially large volume of users.

According to another preferred embodiment of the present invention, both the local and web licensing servers may be operative to provide additional verification during execution of a software application that it is being used in compliance with the licensing terms thereof. In this embodiment, the local licensing server may be operative to measure the use and reports it to the web licensing server, and the web licensing server may be operative to verify that the measured use complies with the licensing terms.

Since a connection with a server may be intermittent, according to one embodiment of the invention the software application at a user's site keeps running only for a limited period (e.g. one hour, one day, etc.) after the connection with the web licensing server has been disconnected, and if during this period no connection with the server is re-established, the software stops running, limits some functionalities, etc.

According to one embodiment of the invention, if one of the servers gets suspended (e.g. because of a system failure), then the other server, if available, performs the licensing activity (checking the authorization of a user to use the application,. checking out that the number of users that use the application simultaneously do not exceed the license terms, etc.).

A byproduct of monitoring the use of an application during its. execution over its licensing terms is accumulating information of the use of the application. For example, instead of installing a dedicated system for monitoring the use of the dictionary feature of a word processor, the licensing application can accumulate this information. The accumulated information can provide an organization means to decide whether to purchase a feature or an application, how many licenses to purchase, etc. Additionally, the application's manufacturer can use such information in the same manner.

The licensing server of the present invention may be utilized in conjunction with a variety of payment models. For example, according to one embodiment of the present invention, the payment may be based on the number of times a user, or a plurality of users, have activated the application. According to another embodiment of the present invention, the payment may be based on the period of time the application was operating. Additionally or alternatively, the payment may be based on any suitable combination of the number of times the application was invoked and the period of time the application was in use. According to another embodiment of the present invention, the payment may be based on the maximum number of instances running simultaneously.

In the art it is common to separate the R&D activity of a software application from the R&D activity of the protection/licensing, in order to facilitate the R&D process. Moreover, there are firms that specialize in protection/licensing issues. Protection shields are designed to be easily added to an existing software application. In addition, protection shields are provided with an API (Application Software Interface), by which a software manufacturer can interact with the protection shield. The fact that a protection shield is a tool separate from the rest of the application allows an application software developer to focus its R&D on subjects which the developer specializes in. Preferably, in the present invention, the parts of the software application that are executed on the WWW server, and thereby kept distant from the end user/organization, belong to the protection shield.

Envelope protection offers file encoding and advanced anti-debugging features which enhance the overall level of security. For example, the HASP Envelope utility is a typical protection envelope. It adds a protective shield around executable and library files of an application. The HASP Envelope provides means to counteract reverse engineering and other anti-debugging measures. The HASP Envelope wraps the application file with numerous protection layers that are assembled randomly. The random multi-layer wrapping envelope ensures that implemented protection strategies differ from one protected application to another. The HASP Envelope establishes a link between the protected software and the HASP Key, which is a “security token”—a hardware device external to a host which provides protection and security functionality to the host via wired or wireless connection with the host. The link between the protected software and the HASP key is broken whenever the protected software cannot access the required HASP Key, in which case the program ceases to function. During the protection process the original file is destroyed and a new one is created. The new file created is the one that is distributed to the users;

The HASP allows detection of both system and user-level debugging measures, which can be activated to be undertaken by the HASP system to block potential attacks that seek to undermine the protection scheme. The user can specify the frequency of HASP Key access for scrambling. The setting controls the compactness of the HASP Key calls made by the protected application. An Encryption Level slider is provided to determine the frequency of HASP Key access for scrambling. Increasing the number of protective modules increases the startup time for a protected application and the resultant file size. There is also a trade-off between encryption level and protected file size and startup speed. A higher encryption level causes a slower startup, and a larger protected application size.

According to another embodiment of the present invention, the licensing server is operative to utilize an “enforcement scheme”, where a user or organization is limited in its use of the application by the license term purchased. In this embodiment, an organization cannot simultaneously use more licenses than have been purchased. According to another embodiment of the present invention, the licensing server is operative to utilize a “metering scheme”, where the use of the program is metered, and the user/organization is charged accordingly. In this embodiment, an organization is charged according to the number of times its users have executed a software application. According to yet another embodiment of the invention, the licensing server is operative to utilize both an enforcement scheme and a metering scheme. In this embodiment, for example, if the licensing term allows up to N simultaneous users, the organization is charged an additional fee if more than N users use the application simultaneously.

It is appreciated that according to the present invention a user may activate an application software from outside an organization's LAN, e.g. from home, since the connection with the web licensing server is via the Internet.

It is further appreciated that the subject of “selective” communication over a network is well known in the art. For example, a user browsing a web site is limited to access only certain content that resides on the web server which operates the web site. Thus, the fact that a user can access data on the web site does not mean that his access to the data is unlimited. Furthermore, the fact that a user communicates with a remote server does not necessarily mean that the remote server has unlimited access to the user's machine. In fact, the user can prevent the web site server from accessing information stored on his computer. Thus, according to a preferred embodiment of the invention, the communication between the parts of a software application that reside on different computer machines is “selective”. Thus, the server is preferably configured and/or programmed and operative to completely or selectively prevent amendment and/or access by remote workstations of information stored thereupon, while enabling at least selective access by the remote workstations to the information stored on the server.

Those skilled in the art will appreciate that the invention can be embodied by other forms and ways, without losing the scope of the invention. The embodiments described herein should be considered as illustrative and not restrictive.

1. A method for protecting a software application from unauthorized use, the method comprising the steps of:
executing a first part of said software application by a user's machine; and
executing a second part of said software application by a remote server connected to the user's machine via a network, said remote server being configured to render the second part accessible for use but not amendable by said user's machine via the network;
wherein, if execution of at least one of said first and second parts requires communication therebetween, said first part and said second part communicate via said network;
thereby preventing hacking of at least said second part of said software application by said user's machine.

2. A method according to claim 1, wherein said second part of said software application performs licensing activity relating said software application.

3. A method according to claim 2, wherein said licensing activity is selected from a group comprising: verifying that said software application is executed according to license terms thereof, verifying that said user's machine and/or a user thereof is authorized to execute said software application, periodically verifying that said user's machine and/or a user thereof is authorized to execute said software application.

4. A method according to claim 1, wherein said network is a wide area network.

5. A method according to claim 1, wherein said network is a local area network.

6. A method according to claim 1, wherein said first part of said software application is protected by a protection shield.

7. A method according to claim 1, wherein said second part of said software application is protected by a protection shield.

8. A method according to claim 1, wherein said second part of said software application is selected from a group consisting of: an executable, a data object, an executable and a data object.

9. A method according to claim 8, wherein said data object comprises a key.

10. A method according to claim 9, wherein said key is selected from a group comprising: cryptographic key, identification key.

11. A method according to claim 1, wherein said communicating is selective.

12. A method according to claim 1, wherein said communicating is secured.

13. A software application, comprising:
a first part, to be executed on a user's machine;
a second part, to be executed on a remote server accessible by said user's machine over a network, thereby keeping said second part away from said user's machine;
a communication module, for communicating between said first part and said second part;
whereby preventing hacking said software application.

14. A software application according to claim 13, wherein said network is a wide area network.

15. A software application according to claim 13, wherein said network is a local area network.

16. A software application according to claim 13, wherein said first part is protected by a protection shield.

17. A software application according to claim 13, wherein said second part is protected by a protection shield.

18. A software application according to claim 13, wherein said communication module is protected by a protection shield.

19. A software application according to claim 13, wherein said second part of said software application is selected from a group consisting of: an executable, a data object, an executable and a data object.

20. A software application according to claim 19, wherein said data object comprises a key.

21. A software application according to claim 20, wherein said key is selected from a group comprising: cryptographic key, identification key.

22. A software application according to claim 13, wherein said communicating is selective.

23. A software application according to claim 13, wherein said communicating is secured.
